(19) United States
(12) Patent Application Publication
(10) Pub. No.: US 2015/0186377 A1
(43) Pub. Date: Jul. 2, 2015

(54) Dynamically Sharing Intents

(71) Applicant: Google Inc., Mountain View, CA (US)

(72) Inventors: Gavin James, Los Angeles, CA (US); Justin Lewis, Marina del Rey, CA (US)

(73) Assignee: Google Inc., Mountain View, CA (US)

(21) Appl. No.: 14/142,540

(22) Filed: Dec. 27, 2013

(51) Int. Cl. G06F 17/30

(52) U.S. Cl. CPC G06F 17/3053

(57) ABSTRACT

A system and method for sharing a plurality of intents via an application executed on a device, the application serving content from a content provider is described. The system includes an application detector to detect an application executed via an operating system on the device to serve the plurality of the intents; an available intent retriever to retrieve a plurality of operating system intents associated with the operating system; an intent selector to select amongst the plurality of operating system intents to serve as the plurality of intents via the application; and an intent order module to determine an order of serving for the plurality of intents.

### BACKGROUND

Content providers serve as a repository for content. A content provider may allow access via a network, such as the Internet, and serve content to various visitors to the content provider. The content may be text, audio, video, or combinations thereof. Further, the content may include meta data, and when the meta data is clicked-through, the visitor may be redirected to another site or application.

The visitor may employ a device, such as computer, mobile device, smart television, and the like to access the content provider. In certain cases, the visitor may employ several devices to access various content providers. Further, the visitor may enter in an authentication, thus registering with one or more of the content providers. In this way, the content provider may be configured to serve content and provide an experience custom-tailored to the specific visitor's preference.

A visitor may consume or view the content on a first source, and be incentivized to share the content onto a second source. For example, the first and second source may be different social networking services. In the above example, the visitor may desire to share the content on the first source with the visitor's connections on the second source. In this way, the content may be distributed.

In order to facilitate the sharing of content, the first source may implement intents. The intent is a clickable link or icon, and in response to being engaged, facilitates the sharing of the content being consumed. Thus, the visitor may not have to perform many options associated with the sharing of content. Each content provider may determine a set of intents to display to a specific visitor.

In cases where the serving of content is monetized, by sharing the content onto another service, a greater amount of monetization may be realized. This may be due to the fact that the content is capable of reaching a larger audience. Thus, by facilitating the sharing of content, the source content provider is essentially incentivizing the sharing of content.

### SUMMARY

A system and method for sharing a plurality of intents via an application executed on a device, the application serving content from a content provider is described. The system includes an application detector to detect an application executed via an operating system on the device to serve the plurality of the intents; an available intent retriever to retrieve a plurality of operating system intents associated with the operating system; an intent selector to select amongst the plurality of operating system intents to serve as the plurality of intents via the application; and an intent order module to determine an order of serving for the plurality of intents.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example of a system for dynamically sharing intents via an application on a device.

FIG. 3 illustrates an example method for dynamically sharing intents via an application on a device.

FIG. 4 illustrates an example method for implementing a method described in FIG. 3 with an operating system without the capability of querying intents.

FIGS. 5(a) and (b) illustrate an example implementation of the system described in FIG. 2.

### DETAILED DESCRIPTION

A content provider provides content, such as video, audio, text or combinations thereof, to visitors to the content provider. The content provider may be accessed via a browser installed on a visitor's device. Thus, when the visitor accesses the content provider site, through a universal resource locator (URL), the visitor is provided an interface served by the content provider. The visitor may access content via the interface.

In another example, the visitor may employ an application installed on a device, such as a mobile device. The application may be installed on an operating system associated with the device, and be configured to provide access to a specific content provider.

In cases where the visitor accesses a specific content provider, through either a browser or an application, the visitor may be presented intents. An intent is a graphical user interface (GUI) element that allows the visitor to share content associated with the intent to another content provider or application. By clicking or accessing the intent, the content is automatically posted on the associated content provider. Thus, if a visitor shares content via an intent from a first content provider (i.e., a first social network) to a second content provider (i.e., a second social network), the shared content may be presented via a visitor's personal page associated with the second social network. In this way, the visitor is able to share content with a larger audience.

The intent automates the process of sharing. Thus, sharing content may be performed more seamlessly without requiring the visitor to leave the first content provider. Thus, the content may be shared with a greater audience without the first content provider requiring the visitor to exit the first content provider's site or application.

Intents may be presented in different forms based on how the content provider is accessed. In certain cases, the intents may be provided as clickable links on a site accessed via the browser (“link intents”). The link intents, in this context, are placed as links or icons surrounding a presently accessed content item. In response to one of the intents being accessed, a link associated with the content provider in which the content is to be shared to may be accessed. The link may be a URL that directs a browser to activate a page or script associated with the sharing of content. Accordingly, if the content provider is capable of auto-sharing content through link intents, the accessed content provider may automatically populate the visitor's personal page with the shared content.

In another example, the intents may be provided via an operating system associated with an application employed to access the content provider (“operating system intent”). In certain cases, the operating system may populate a list of intents based on applications installed on the operating system. In other cases, the operating system may not have this capability. When an operating system intent is accessed, a second application associated with the second content provider may be accessed, and the sharing of content between a first and second content provider may be facilitated by a background process.

However, when providing a list of intents, the visitor accessing the application may not get a full list of intents in an ideal order. For example, the list of intents may be alphabetized, and thus, not reflective of the visitors preferences or past activities. Further, the list of intents may only reflect applications with associated intents (i.e. operating system intents). In certain cases, the implementer of an intent may prefer that the intent that is provided to a specific visitor is a link intent (and not an operating system intent). For example, the visitor may not have the application installed or the second content provider may only be associated with link intents.

Disclosed herein are methods and systems for dynamically sharing intents. By serving the operating system intents with the aspects disclosed herein, a visitor is provided a more personalized experience. In this way, the visitor receives intents that match the visitor's personal preferences, mobile device capabilities, and previous access history. Further, in cases where an operating system does not auto-populate a list of content providers with intents, the aspects disclosed herein provide an alternate method of dynamically sharing operating intents.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

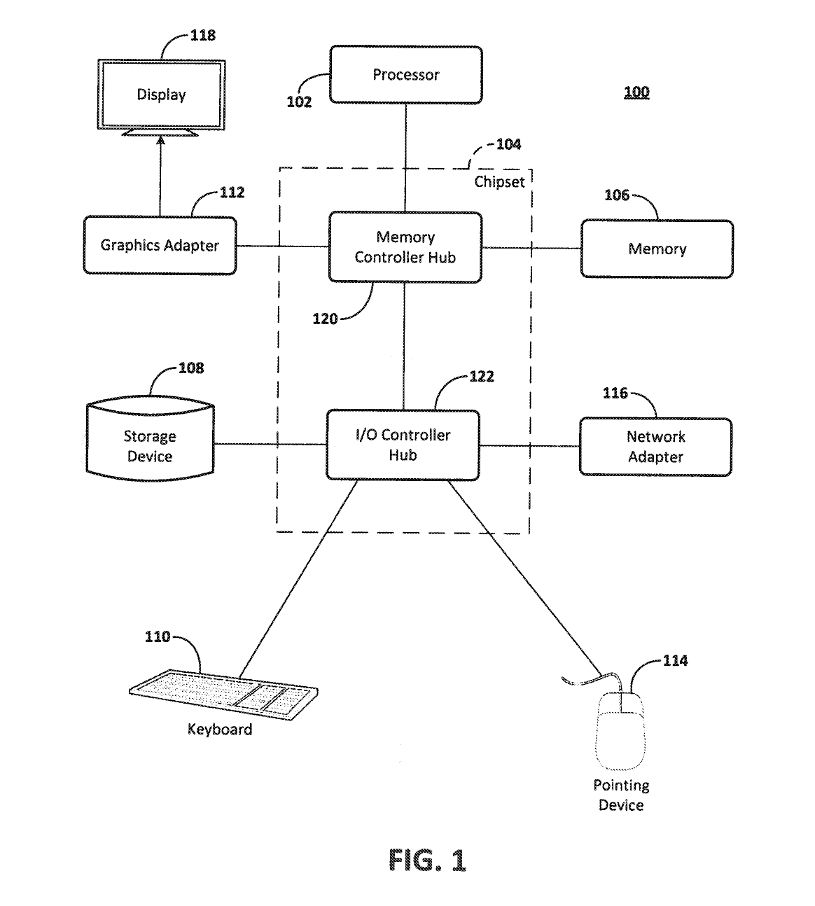

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network 250.

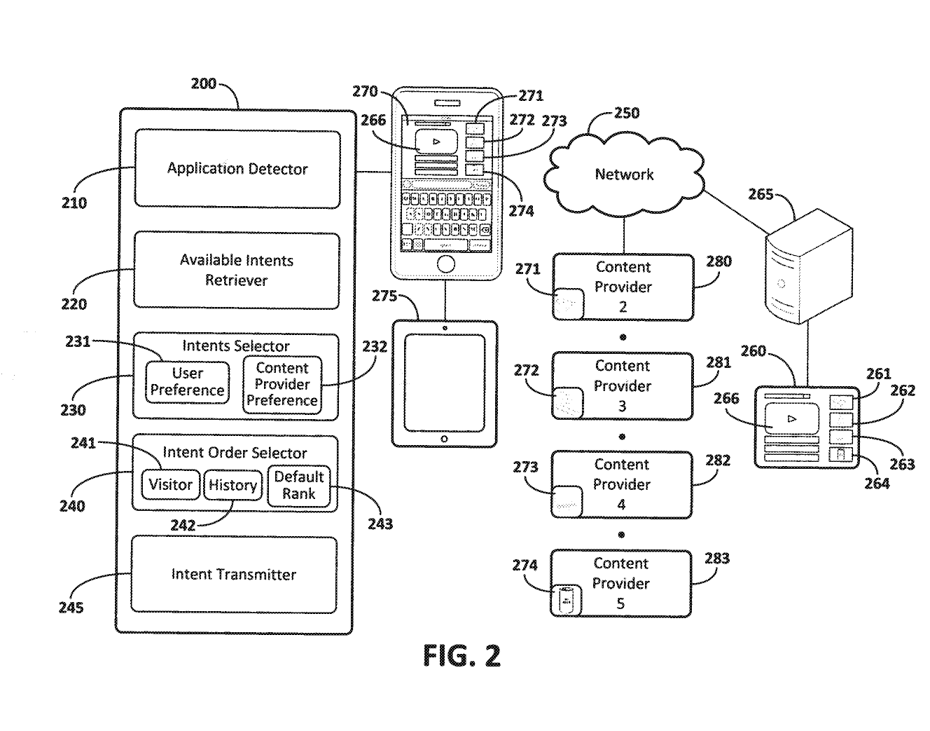

FIG. 2 illustrates an example of system 200 for dynamically sharing intents via an application 270 on a device 275. The system 200 includes an application detector 210, an available intent retriever 220, an intent selector 230, an intent order selector 240, and an intent transmitter 245. The system 200 may be implemented via an application associated with a visitor's device 275, via an operating system associated with the visitor's device 275, or executed on a server that provides data to the visitor's device 275.

An application 270 is associated with a first content provider, content providing service 260. The application 270 is configured to allow an operator of device 275 to access content via the content providing service 260, and allow the operator of device 275 to engage and interact with the content providing service 260.

As shown in FIG. 2, the application 270 also serves operating system intents. Intent 271 is associated with content provider 2 (280), intent 272 is associated with content provider 3 (281), intent 273 is associated with content provider 4 (282), and intent 274 is associated with content provider 5 (283). The application 270 presently serves content item 266, and when any of the intents are engaged, the application 270 automatically shares the content item 266 with the associated content provider.

The content providing service 260 may also be accessed via a browser. In those situations, the content providing service 260 may serve link intents, such as intents 261-264. Intents 261-264 have the same associations as intents 271-274, respectively. In response to each of the intents being engaged (for example, being clicked-through), content presently being served by the content providing service 260 via a web browser is automatically shared to the associated content provider. The link intents may be associated with an assigned URL provided by each of the associated content providers that indicate a sharing to the associated content provider is requested.

The application detector 210 detects the application being executed via the visitor's device 275. The application detector 210 initiates the detection in response to an application instigating a call to a sub-routine or function that requests a serving of intents. For example, in response to content being presently consumed, the application 270 may request intents to be simultaneously presented (or presented after the content is served).

The available intent retriever 220 accesses the visitor's device 275, and ascertains whether the visitor's device 275 contains applications that have associated operating system intents. Certain operating systems are configured to allow this request, while other operating systems may not have this feature implemented. In the cases where the operating system does not include this feature, an alternative sub-routine may be provided, as described below with regards to method 400. The operating system intents may employ a built-in feature associated with an associated application that is configured to share content presently being consumed.

In addition to searching for available intents based on installed applications, the available intent retriever 220 may ascertain intents associated with the specific visitor, the visitor's device 275, or intents associated with the content provider service 260.

The intent selector 230 selects intents associated with the content being served, the visitor associated with the visitor's device 275, and other parameters. The intent selector 230 includes a visitor preference module 231 and a content provider module 232.

The intent selector 230 defaults by associating each of the available intents with an operating system intent if an application associated with the intent is installed on the visitor's device 275, and the application has the capability to provide functionality with an operating system intent. If an operating system intent does not exist for the available intent, a link intent is selected (if also available).

In certain cases, the intent selector 230 may employ a link intent if the visitor preference module 231 indicates that a specific visitor has preset that the link intent is to be used. Accordingly, the intent selector 230 may also employ a link intent if the content provider module 232 has preset that a link intent is to be used as well. The content provider module 232 may receive data from the content provider service 260.

For example, referring to FIG. 2, if the intents to be provided are connected to content providers 2-5 (280-283), the intent selector 230 may select any of the operating system intents 271-274 or the link intents 261-264.

The intent order selector 240 selects an order of the selected intents to present. The intent order selector 240 may employ any combination of the algorithms associated with the visitor order module 241, a history order module 242, or a default order module 243.

The visitor order module 241 selects an ordering based on aspects associated with the visitor. For example, the visitor order module 241 may determine that the intents with associated operating system intents are to be presented first. In another example, the visitor may have preset the order of intents, and the visitor order module 241 may instruct the system 200 to present the order of intents based on the visitor's predetermined settings.

The history order module 242 bases the order of the intents based on a visitor's history or access record. For example, the history order module 242 may set the order based on the intents associated with content providers the visitor has accessed most recently. In another example, the history order module 242 may set the order based on the intents associated with content providers the visitor has accessed with the greatest frequency, or the content providers the visitor has shared the most to.

The default order module 243 may set the order of the intents based on a default setting. Thus, the application may maintain a listing of various content providers, and set the order of the intents accordingly.

The intent transmitter 245 transmits the intents based on the order, the intents selected, and the available intents, as determined by system 200. The intent transmitter 245 transmits the intents to the application 275 installed on the visitor's device 275. Accordingly, the application may be configured to employ a GUI element to display the various intents transmitted in the determined order.

The visitor's device 275 may store the transmitted intents, and reuse the data (such as the ordering, for example) with other applications executed on the visitor's device 275.

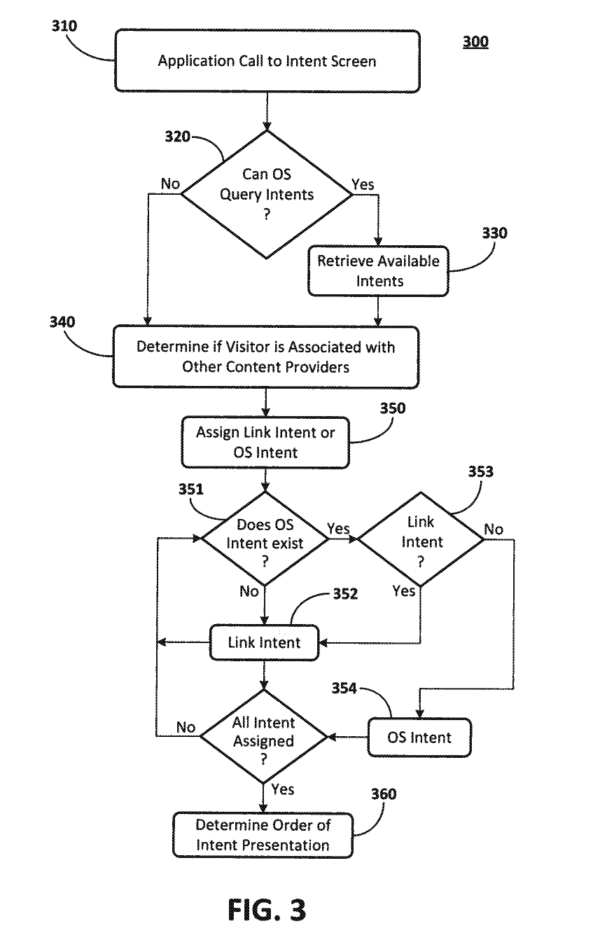

FIG. 3 illustrates an example of method 300 for dynamically sharing intents via an application on a device. The method 300 may be implemented on a device, such as system 200.

In operation 310, a detection of an application installed or executed on a mobile device making a call to an intent screen is made. The intent screen may be called when a request to share content is made. Alternatively, the intent screen may be situated on an application screen nearby a content serving portion of the application.

In operation 320, a determination is made as to whether an operating system the application in operation 320 is installed on is capable of querying intents. Querying intents is an automated function that allows the application to detect if other applications installed on the operating system are capable of providing intent information. Accordingly, the presently executed application may employ the intent information to populate an intent screen. Certain operating systems provide this functionality (operation 330), while other operating systems fail to provide this functionality (operation 340).

In operation 330, the application employs the operating system to determine the available intents associated with installed applications. The list of available intents may be stored, and employed in various portions of the operation of method 300. After which, the method 300 may proceed to operation 340.

In operation 340, a determination is made as to whether the visitor executing the application detected in operation 310 is associated with other content providers. For example, the application detected in operation 310 may be an application for accessing a first content provider. Further, the operator of the mobile device on which the mobile application is installed or executed on may be logged into the first content provider. The first content provider may maintain a history of other content providers associated with the visitor. For example, if the visitor has shared content from the first content provider to other content providers, the first content provider or the application may maintain a history of this sharing. In another example, the visitor may manually enter a list of other content providers the visitor is a member of.

Alternatively, or in addition to, if the visitor is not associated with any other content providers, the visitor may be presented default content providers or options for intents.

In operation 350, the various intents and other content providers ascertained in operations 330 and 340 are associated with either an operating system intent or a link intent. The method 300 may iteratively performs the operations described above for all the ascertained intents and other content providers.

In operation 351, a determination is made as to whether the present intent or content provider being analyzed is associated with an operating system intent. If no, the method 300 proceeds to operation 352. If yes, the method 300 proceeds to operation 353.

In operation 353, a determination is made as to whether a predetermined setting indicates that the link intent overrides the specific operating system intent. In certain cases, an implementer of method 300 may prefer to employ the link intent instead of the operating system intent. If yes, the method 300 proceeds to operation 352, if no, the method 300 proceeds to operation 354.

If the method 300 proceeds to operation 352, the specific intent or content provider is associated with a link intent. If the method 300 proceeds to operation 354, the specific intent or content provider is associated with an operating system intent.

In operation 355, a determination is made as to whether all ascertained intents or content providers are associated with either a link intent or an operating system intent. If yes, the method 300 proceeds to operation 360. If no, the method 300 proceeds back to operation 351, and proceeds with operations 351-354 for another intent or content provider.

In operation 360, an order of the associated link intents or operating system intents is determined. The implementer of method 300 may employ various heuristics for performing the ordering such as those described above with regards to the order selector 240. For example, the order may be contingent on the content providers most recently accessed by the visitor or the mobile device. In another example, the implementer of the application may set rankings based on a desired order. In another example, the ordering of intents may be set based on a frequency of accesses by the visitor to the various content providers. For example, if a visitor accessed a first content provider associated with a first intent ten times, and a second content provider associated with a second intent five times; in operation 360, the first intent (either the operating system intent or link intent) may be presented first.

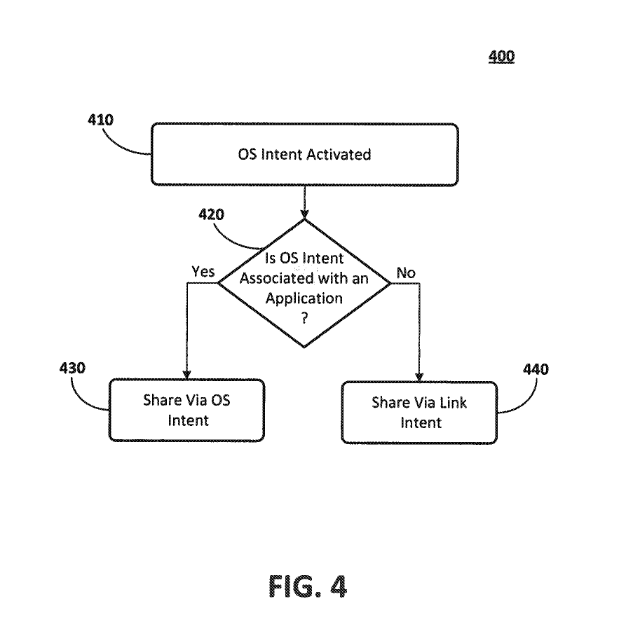

FIG. 4 illustrates an example method 400 for implementing method 300 with an operating system without the capability of querying intents. The method 400 may be performed on a device, such as system 200.

In operation 410, after an intent screen has been presented (either during or after content is being presented), an operator of a device may initiate one of the intents. The decision to initiate the intent may be caused by a desire of the operator to share the content presently being consumed. In creating the intent screen, the application creator may populate the choices of available intents with common or popular operating system intents. Due to the operating system's limitation, the knowledge of whether the operating system intents are available may not be known before populating the selection of intents. Thus, a default option of displaying operating system intents may be employed.

In operation 420, a determination is made as to whether the operating system intent initiated is associated with a presently installed application. If the operating system has the presently installed application, the method 400 proceeds to operation 430. If no, the method 400 proceeds to operation 440.

In operation 430, the application shares content via the operating system intent. As explained above, the operating system intent makes a call to the installed application, which subsequently shares the content being presently consumed. At this juncture, the method 400 may also record that the intent initiated is associated with an operating system intent.

In operation 440, the application accesses a link intent associated with the initiated intent, and subsequently shares the content presently being consumed via the link intent. Accordingly, the method 400 may also record that a link intent is associated with the initiated intent for a specific intent.

In both operations 430 and 440, a record of which intents are associated with a link intent and an operating system intent is made. Accordingly, the method 400 may not have to be repeated after an association is made. However, various applications may be updated or an application may be installed or uninstalled on the operating system. Thus, whether the initiated intent is associated with an operating system intent may periodically change over time. Thus, at a predetermined time, the record of whether an intent is associated with an operating system intent or a link intent may also change over time. Accordingly, the method 400 may be repeated at a predetermined time, even if an association via operations 430 and 440 are already made.

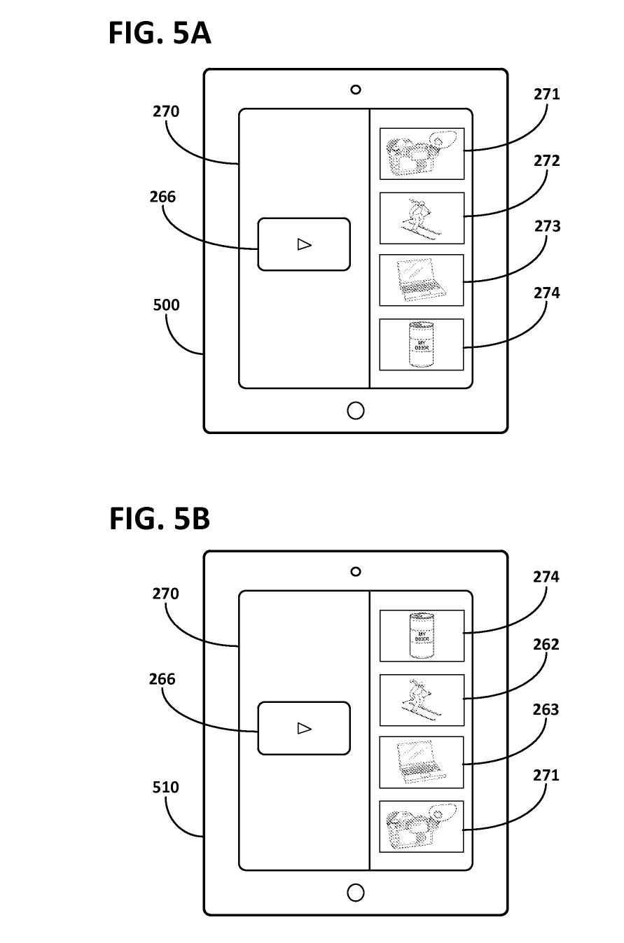

FIGS. 5(a) and (b) illustrate an example implementation of the system 200.

Referring to FIG. 5(a), an application 270 being executed on device 500 presenting content 266 is shown. Conversely, various intents 271-274 are also shown. The intents 271-274, as described in FIG. 2, are associated with various operating system intents. Thus, in response to the various operating system intents 271-274 being initiated, content 266 is shared to the associated service or content provider.

Device 500 does not employ any of the methods or systems disclosed herein. Thus, the operating system intents 271-274 are shown in an order in which the operating system intents are retrieved, or in an alphabetical order.

Referring to FIG. 5(b), device 510 is shown. Device 510 is similar to device 500, except device 510 employs system 200 described herein. Accordingly, the various intents shown, operating system intent 274, link intent 262, link intent 263, and operating system intent 271, are ordered and selectively presented employing the aspects disclosed herein. Thus, decision to employ an operating system intent or a link intent, and the order of the various intents is contingent on the visitor receiving the content 266, the visitor or the application creator's preference, the visitor's previous sharing history, the applications installed on device 510, or a combination thereof.

Specifically, system 200 determines that the ordering of content providers associated with the visitor accessing content 266 via application 270 is the following:
1) the content provider associated with operating system intent 274,
2) the content provider associated with operating system intent 272,
3) the content provider associated with operating system intent 273, and
4) the content provider associated with operating system intent 271.

Further, the system 200 also determines that link intents 262 and 263, instead of operating system intents 272 and 273, are to be presented. This may be due to operating system intents for the associated content providers not existing, or a predetermined setting. Accordingly, as shown if FIG. 5(b), the various intents are presented in a deliberate order, along with either an operating system intent or link intent based on a determination by system 200.

Thus, according to the aspects disclosed herein, operating system intents and link intents are selectively provided, and presented in an order based on various parameters. Because the various parameters correspond to a visitor's usage, or an application creator's preference, the sharing of content becomes more deliberate and implemented in a more efficient manner.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3 and 4. The disclosed devices, components, and systems contemplate using or implementing any suitable technique for performing the steps illustrated in these figures. Thus, FIGS. 3 and 4 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

We claim:

1. A system for sharing a plurality of intents via an application executed on a device, the application serving content from a content provider, comprising:
a data store comprising a computer readable medium storing a program of instructions for the sharing of the plurality of the intents;
a processor that executes the program of instructions;
an application detector to detect the application executed via an operating system on the device to serve the plurality of the intents;
an available intent retriever to retrieve a plurality of operating system intents associated with the operating system;
an intent selector to select amongst the plurality of operating system intents to serve as the plurality of intents via the application; and
an intent order module to determine an order of serving for the plurality of intents.

2. The system according to claim 1, wherein, in response to an operating system intent not existing for a selected one of the plurality of intents, the intent selector selects a corresponding link intent.

3. The system according to claim 1, wherein the intent selector overrides the selection of one of the plurality of operating systems intents with a corresponding link intent based on a predetermined setting.

4. The system according to claim 1, wherein the order is based on a visitor's preference, the visitor being associated with the application.

5. The system according to claim 1, wherein the order is based on a visitor's history, the visitor being associated with the application.

6. The system according to claim 5, wherein the visitor's history includes information about the visitor's prior accesses to other content providers.

7. The system according to claim 5, wherein the visitor's history includes information about the visitor's prior shares to other content providers.

8. The system according to claim 1, wherein the order is based on the content provider's default rankings.

9. The system according to claim 1, wherein in response to the operating system not supporting a feature of retrieving the plurality of operating system intents:
presenting the plurality of operating system intents from a predetermined set of available operating system intent; and
determining if one of the plurality of operating system intents exists in response to the one of the plurality of operating system intents is selected.

10. A method implemented on a processor for sharing a plurality of intents via an application executed on a device, the application serving content from a content provider, comprising:
detecting the application making a call for the plurality of intents;
retrieving a plurality of operating system intents based on an operating system the application is executed on;
selecting, based on the retrieved plurality of operating system intents, the plurality of intents to serve via the application; and
determining an order of serving for the plurality of intents,
the detecting, the retrieving, the selecting, or the determining being performed via the processor.

11. The method according to claim 10, wherein, in response to an operating system intent not existing for a selected one of the plurality of intents, selecting a corresponding link intent.

12. The method according to claim 10, further comprising overriding the selection of one of the plurality of operating systems intents with a corresponding link intent based on a predetermined setting.

13. The method according to claim 10, wherein the order is based on a visitor's preference, the visitor being associated with the application.

14. The method according to claim 10, wherein the order is based on a visitor's history, the visitor being associated with the application.

15. The method according to claim 14, wherein the visitor's history includes information about the visitor's prior accesses to other content providers.

16. The method according to claim 14, wherein the visitor's history includes information about the visitor's prior shares to other content providers.

17. The method according to claim 10, wherein the order is based on a content provider's default rankings.

18. The method according to claim 10, wherein in response to the operating system not supporting a feature of retrieving the plurality of operating system intents:
presenting the plurality of operating system intents from a predetermined set of available operating system intent; and
determining if one of the plurality of operating system intents exists in response to the one of the plurality of operating system intents is selected.

19. A method implemented on a processor for sharing a plurality of intents via an application executed on a device, the application serving content from a content provider, comprising:
detecting the application making a call for the plurality of intents;
assigning a plurality of operating system intents based on the plurality of intents to serve via the application; and
determining an order of serving for the plurality of intents,
the detecting, the assigning, or the determining being performed via the processor.

20. The method according to claim 19, further comprising in response to one of the plurality of operating system intents not existing when the one of the plurality of operating system intents is selected, selecting a link intent associated with the one of the plurality of operating system intents.
